(19) United States
(12) Patent Application Publication
(10) Pub. No.: US 2016/0174750 A1
(43) Pub. Date: Jun. 23, 2016

(54) PART DRIVING STRUCTURE OF COFFEE MACHINE

(71) Applicant: NINGBO SEAVER ELECTRIC APPLIANCE CO., LTD., Yuyao (CN)

(72) Inventor: Tianping WANG, Yuyao (CN)

(73) Assignee: Ningbo Seaver Electric Appliance Co., Ltd., Yuyao (CN)

(21) Appl. No.: 14/899,527

(22) PCT Filed: Apr. 30, 2014
(86) PCT No.: PCT/CN2014/000453

§ 371 Date: Mar. 7, 2016

(30) Foreign Application Priority Data
Jun. 18, 2013 (CN) 201310240322.9

(51) Int. Cl. A47J 31/36

(52) U.S. Cl. CPC A47J 31/3633

(57) ABSTRACT

Disclosed is a part driving structure of a coffee machine, comprising a base (1); a first part (2); a second part (3); a pushing board (4); a driving rod (5) which is connected to the bottom surface of the pushing board; a first transmission rod (6) which is pivotally connected to the rear end of the second part (3); and a second transmission rod (7) which is pivotally connected to the back of the base (1). The lower end of the driving rod (5), the rear end of the first transmission rod (6) and the front end of the second transmission rod (7) are movably sheathed on one and the same transmission shaft (8). With the action of the forward and backward horizontal movements of the pushing board (4), the second part (3) slides back and forth relative to the base (1). Unlike the horizontal movement of the second part (3) realized by means of flipping and pulling the handle up and down in a traditional coffee machine, the pushing board (4) may not become warped upwards during the operating process, and does not additionally occupy the space height, and, therefore, the coffee machine adopting such a driving structure can be used normally even if the coffee machine is placed in a cell of which the height space is reduced, and has better adaptability of use.

### TECHNICAL FIELD

The present invention relates to a coffee machine working with coffee capsule, more particularly, to a part driving structure of a coffee machine for driving parts of the coffee machine to move.

### PRIOR ART

A coffee machine is a machine for preparing of coffee beverage, and conventional components of the coffee machine include a water tank, a heating element and a water pump, etc.; in use a capsule containing coffee powder is brought into the coffee machine, and then in use two parts inside the coffee machine are driven by a driving structure to be closed together so as to form a extraction chamber, at this time the coffee capsule lies in the extraction chamber, and then during the extraction, heated water is pumped by the water pump into the extraction chamber, the water flows through the coffee raw material to be extracted, and then the coffee beverage flows out of a water outlet pipe of the coffee machine into a cup.

In the prior beverage preparation devices, such as coffee machine, the driving structures for moving two parts to close and open the both parts are mostly based on driving structure of handle-linkage type. For example, the Chinese patent for invention No. ZL00812101.X (issue No.: CN1263415Y) with the title “A Device to Extract Material for Preparing Beverage” discloses a part driving structure of handle-linkage type, comprising a closing rod with two arms and two pulling rods, wherein the both arms of the closing rod are fixed to first pivot journals located on both sides of said second part and can rotate about them, and the pulling rods are fixed to second pivot journals located on both sides of said first part and can rotate about them. The ends of the pulling rods and the both arms of the closing rod are securely held together by a third rotatable pivot journal, in order to cooperate with each other so as to close and open the device.

For example, the Chinese patent for utility model No. ZL200720108105.4 (issue No.: CN201019552Y) with the title “A Device to Extract Material for Preparing Beverage” also discloses a part driving structure of handle-linkage type, comprising a handle with two arms, a transmission rod, a linkage, a rotary shaft and a transmission shaft, wherein one end of the transmission rod and the both arms of the handle are securely held together by means of the rotary shaft, and the rotary shaft is supported in a base so as to be rotatable relative to the base; one end of the linkage is pivotally connected to a first guide shaft, and the other end of the linkage and the other end of the transmission rod are pivotally connected together by means of the transmission shaft, in order that the handle, the transmission rod and the linkage rod cooperate with each other so as to close or open the first part and the second part.

When in use of all the prior part driving structures of handle-linkage type, it is necessary to lift up or to depress the handle; prior to placing coffee capsule, the handle is lifted up to an angle, with the handle being warped upwards and occupying a larger height, so only when the coffee machine of this type is placed in a place with a certain spatial height, it can be used, the requirements for placement space of the coffee machine are high and it is user-unfriendly. In addition, in the prior part driving structures of handle-linkage type, locking of the both parts are achieved by the linkage structure, thus, in order to prevent water leakage during the extraction process, there are higher requirements for locking force of the both parts in the coffee machines, such that after the both parts are closed together, due to the very large locking force between the both parts, a larger force is required to actuate the handle and thus the operation is effort-intensive, if man wants to open the both parts again.

### SUMMARY OF THE INVENTION

The technical problem to be solved by the present invention is to provide a part driving structure of a coffee machine with respect to the above-mentioned prior art, in which part driving structure the parts can be actuated to slide only by means of horizontal moving of a pushing board, wherein during operation of this driving structure the pushing board is free of being warped upwards, without additional occupying of spatial height, and it is convenient and effort-saving in operation.

The present invention solves the above-mentioned technical problem by means of the following technical solution: a part driving structure of a coffee machine, comprising a base, a first part provided with a water outlet channel and a second part provided with a water inlet channel;
wherein the first part is fixed to the front end of the base, the second part is restrained within the base and can slide back and forth, and there is a capsule inlet provided in the upper portion of the base;
characterized in that a pushing board that can slide back and forth relative to the base is provided on the top surface of the base, a vertically disposed driving rod is pivotally connected to the bottom surface of the pushing board, a first transmission rod is pivotally connected to the rear end of the second part, and a second transmission rod is pivotally connected to the rear portion of the base, wherein the lower end of the driving rod, the rear end of the first transmission rod and the front end of the second transmission rod are movably sheathed on one and the same transmission shaft.

In order to make the pushing board slide more smoothly and to save force during pushing, a carriage for guide wheels is fixed to the lower end of the above-mentioned pushing board, the guide wheels are mounted on the carriage for guide wheels, and there is a guide shaft provided in the inner upper portion of the base respectively on the left and the right side, wherein wheel grooves on the guide wheels are in contact with the guide shafts, and the upper end of the driving rod is pivotally connected to the carriage for guide wheels by means of its own pivot journal. By contact limit realized by the guide wheels on the carriage for guide wheels and the guide shafts, the pushing board can be prevented from shaking during sliding, and at the same time because the guide wheels and the guide shafts are in rolling contact during sliding of the pushing board, the pushing board slides more easily.

The above-mentioned carriage for guide wheels is fixed underneath the pushing board by means of screws, and there are two mounting places for guide wheels provided respectively on the left and the right side of the carriage for guide wheels, wherein each of the guide wheels is mounted in one mounting place for guide wheel respectively, and the wheel grooves on the guide wheels on either side are in contact with the guide shaft on the corresponding side. By the contact limit realized by more than one guide wheel and guide shaft, the pushing board is more effectively prevented from shaking during sliding, and at the same time the pushing board slides more easily. The number of guide wheels may be set according to need.

A first front magnet is inserted in the front end of the above-mentioned carriage for guide wheels, and a second front magnet that corresponds to the first front magnet is inserted in the front portion of the base; a first rear magnet is inserted in the rear end of said carriage for guide wheels, and a second rear magnet that corresponds to the first rear magnet is inserted in the rear portion of the base; and in the state where the second part is actuated by the pushing board forward to be closed together with the first part, the first front magnet and the second front magnet attract together with each other, while in the state where the second part is actuated by the pushing board backward until the first part and the second part are completely opened, the first rear magnet and the second rear magnet attract together with each other. When the pushing board moves back and forth to two limit states, warning tone is generated by the attraction of the front and rear magnets, reminding us that the pushing board has been moved in place, which may also enhance touch feeling while moving the pushing board.

The above-mentioned pushing board can cover said capsule inlet when moving forward to the state where the first part and the second part are closed, while the pushing board opens said capsule inlet when moving backward to the state where the first part and the second part are completely opened. When the coffee machine is not in use, the pushing board covers the capsule inlet, which prevents dusts or foreign objects from entering into the interior of the coffee machine and contaminating or damaging internal parts of the coffee machine, so the coffee machine is more secure and hygienic in use.

Further improvement lies in that: the above-mentioned base comprises a frame and a housing; the frame comprises a front retaining plate, a rear retaining plate and two guide posts supported between the front retaining plate and the rear retaining plate and arranged on the left and the right side parallelly at a distance to each other; wherein the guide posts are movably guided through the housing on the left and the right side so that the housing and the frame can slide relative to each other back and forth; there is a support spring sheathed on the both guide posts respectively, and the support springs are supported between the front retaining plate and the front end face of the housing; the capsule inlet is disposed in the housing, the first part is fixed to the front retaining plate, the second part is sheathed on the corresponding guide posts with its left and right sides and can slide back and forth, and the pushing board is disposed on the upper end face of the housing; a retaining seat having a cavity is fixed to the above-mentioned rear retaining plate, a piston which can slide back and forth is disposed in the cavity of the retaining seat, a seal ring is provided between an outer peripheral wall of the piston and an inner peripheral wall of the cavity, a water inlet chamber is formed between the rear end of the piston and the cavity, and the water inlet chamber is in communication with environment through a cold water channel; and the rear end of the second transmission rod is directly or indirectly pivotally connected to the piston.

Due to the aforesaid structure of the base, the locking force between the first part and the second part is realized in water hydraulic driving manner; firstly, the second part is driven to be closed together with the first part under the push of the pushing board, then cold water under high pressure enters into the water inlet chamber from the cold water channel, the piston is moved forward relative to the retaining seat; because the retaining seat is fixed to the frame and the position of the housing relative to the casing body of the coffee machine is fixed, the frame can move as a whole backward relative to the housing against the support force of the support springs, the first part also moves backward relative to the housing, and the first part and the second part are gradually clamped against each other under the water pressure to form a closed extraction chamber; since the locking of the first part and the second part is provided not by the support force formed by a first and a second linkages, that is, it is enough that the sliding of the pushing board drives the second part to move near or to get into contact with the first part only by two linkages, during back and forth sliding the pushing board does not need to overcome additional stronger locking force brought about by linkages, therefore the present mechanism is effort-saving in operation during driving the parts to move; after the extraction is finished, the water pressure is released, the frame moves forward relative to the housing under the action of the springs, the locking force between the first part and the second part is removed, and the pushing board can be easily pulled to separate the first part and the second part from each other.

The above-mentioned cold water channel is disposed in the piston. Of course, it may also be disposed in the retaining seat.

There is a mounting block provided in the rear portion inside the above-mentioned housing, wherein the mounting block is sheathed on the guide posts with its left and right sides, the rear end face of the mounting block is in contact with the outer end face of the piston, and the rear end of the second transmission rod is pivotally connected to the mounting block by means of pivot portions on both sides of the second transmission rod. This structure simplifies the structure of the piston and is ease to assemble; of course, it is also possible to pivotally connect the rear end of the second transmission rod directly to the outer end face of the piston.

The number of the above-mentioned first transmission rods is two, wherein the front ends of the first transmission rods are pivotally connected to the back of the second part by means of first pivot journals, and the rear ends of the first transmission rods are sheathed on the transmission shaft; that the front end of the second transmission rod has two forwardly extending arm portions, and the front ends of the both arm portions are sheathed on the transmission shaft; the lower end of the driving rod is located between the both arm portions, the both first transmission rods are located outside the both arm portions respectively, and there is a jump ring provided on the left and the right end of the transmission shaft respectively so as to axially restrain the first transmission rods, the second transmission rod and the driving rod. The second part can be pushed forward more smoothly by providing two first transmission rods, and because the second transmission rod has two arms and the driving rod is located in the middle exactly, the driving rod can smoothly actuate the first transmission rods and the second transmission rod to move.

The rear portion of the above-mentioned second part has an inner recess, the front ends of the first transmission rods are pivotally connected inside the inner recess by means of the first pivot journals, in the state where the second part is actuated by the pushing board forward to be closed together with the first part, the lower end faces of the first transmission rods get into contact with the bottom surface of the inner recess, preventing the first transmission rods from further deflecting downward, with the axes of the first transmission rods and the second transmission rod including an obtuse angle, forming a self-locking angle; while the frame moves backward relative to the housing, the pivotable connection end between the first transmission rods and the second transmission rod with respect to each other will not warp upwards under the action of external force, ensuring that the first part and the second part can be pressed together.

Compared to the prior art, an advantage of the present invention lies in that: the operation of the present driving structure is based on the action of the back and forth lateral sliding of the pushing board, the pushing board is connected with the second part and the base by a specially designed linkage structure, to actuate the second part to slide back and forth relative to the base; because the movement of the pushing board is lateral sliding, unlike the horizontal movement of the second part realized by means of flipping and pulling the handle up and down to drive parts in the traditional coffee machines, the pushing board may not become warped upwards during the operating process, and does not additionally occupy the space height, and it is effort-saving during operation, therefore, the coffee machine adopting such a driving structure can be used normally even if the coffee machine is placed in a cell of which the height space is reduced, and has better adaptability of use.

### DESCRIPTION OF THE DRAWINGS

FIG. 1 illustrates a perspective schematic view of a embodiment according to the present invention (in an opened state of a first part and a second part);

FIG. 2 illustrates a cross-sectional view of the embodiment according to the present invention (in the opened state of the first part and the second part);

FIG. 3 illustrates a perspective schematic view of the embodiment according to the present invention (wherein the second part is moved to an intermediate state);

FIG. 4 illustrates a cross-sectional view of the embodiment according to the present invention (wherein the second part is moved to the intermediate state);

FIG. 5 illustrates a perspective schematic view of the embodiment according to the present invention (in a closed state of the first part and the second part);

FIG. 6 illustrates a cross-sectional view of the embodiment according to the present invention (in the closed state of the first part and the second part);

FIG. 7 illustrates a perspective schematic view of the embodiment according to the present invention after removal of a pushing board;

FIG. 8 illustrates a perspective schematic view of the embodiment according to the present invention after removal of the pushing board, a housing and a carriage for guide wheels; and

FIG. 9 illustrates a perspective schematic view of a second transmission rod in the embodiment according to the present invention.

### MODE FOR CARRYING OUT THE INVENTION

In the following context, the present invention will be described in further detail in light of embodiments in the accompanying drawings.

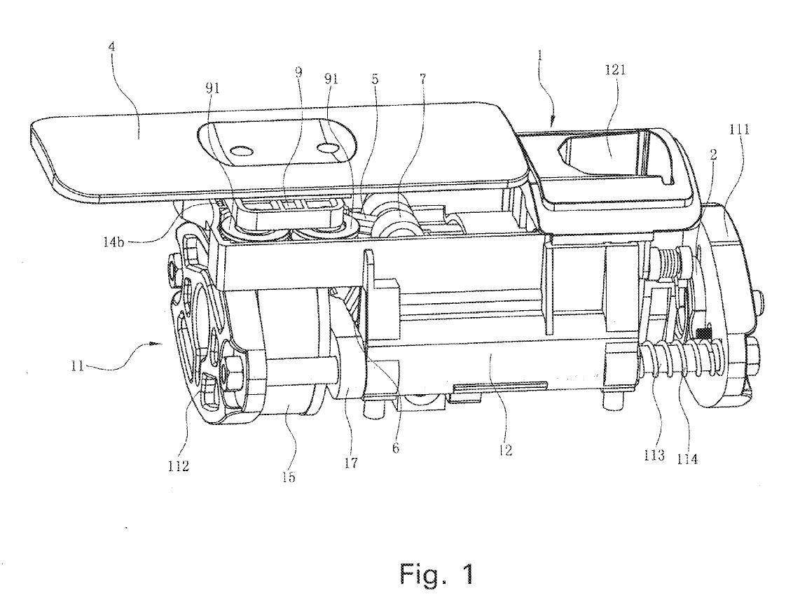

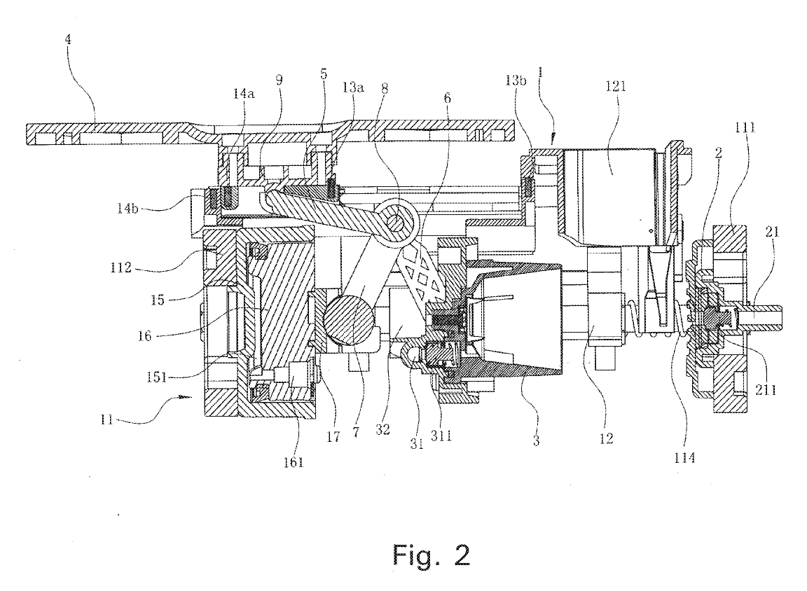

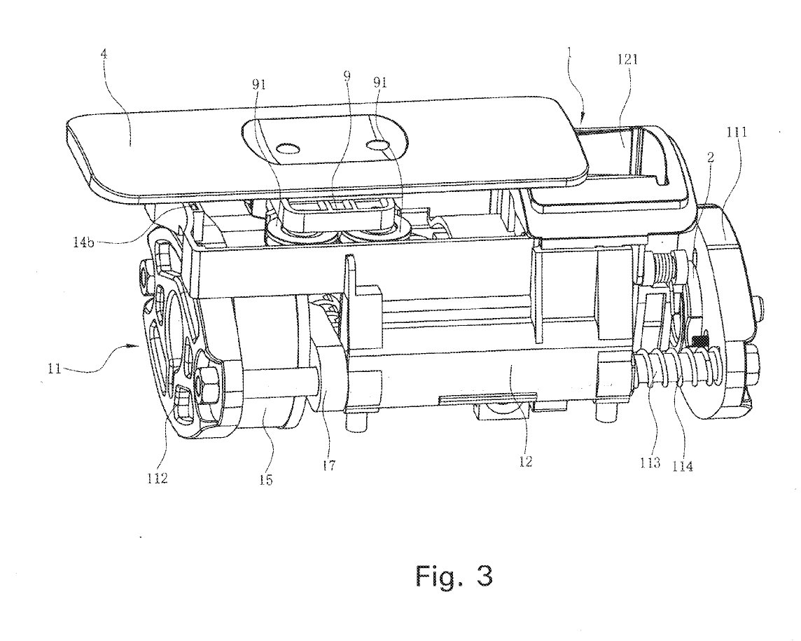

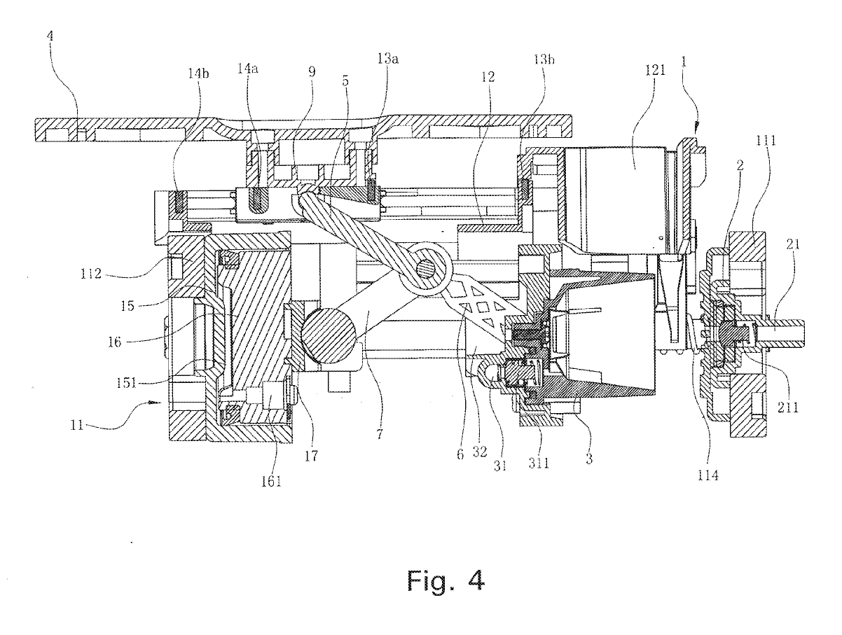

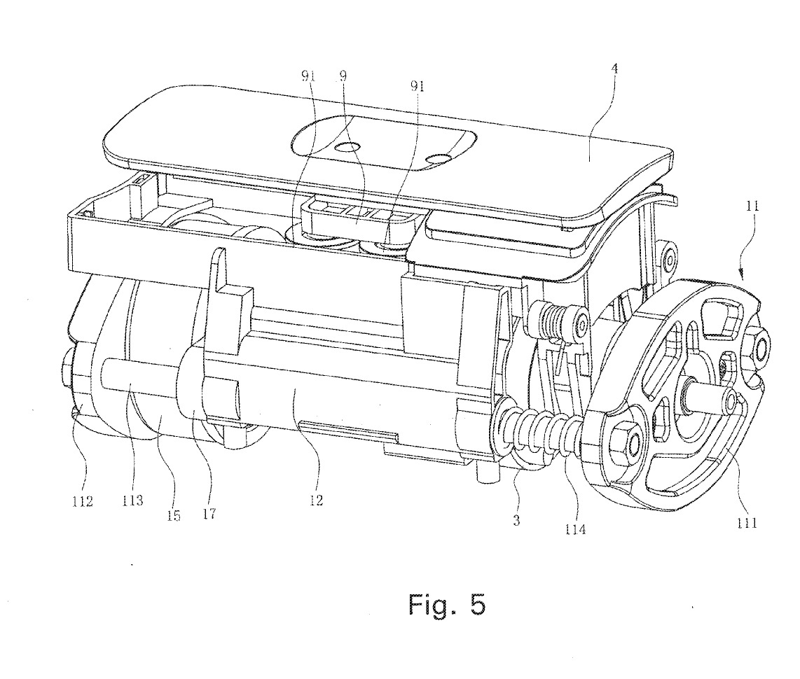

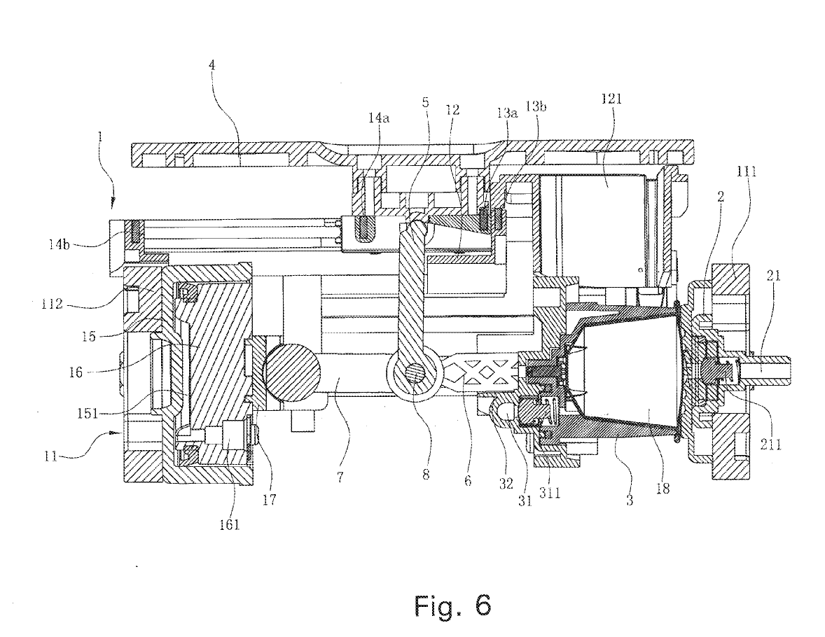

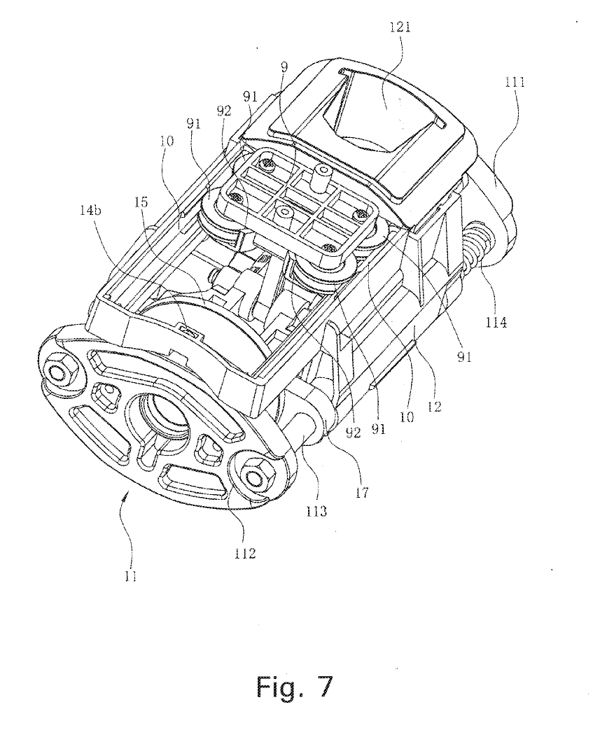

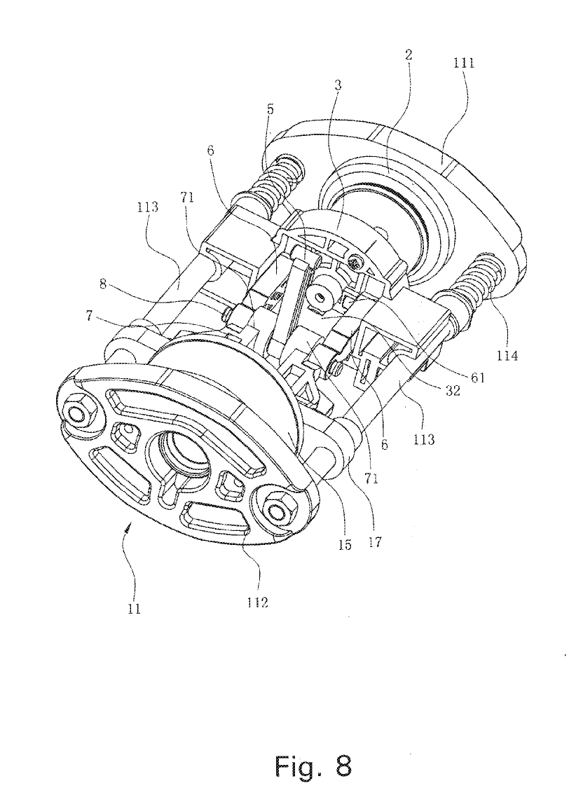

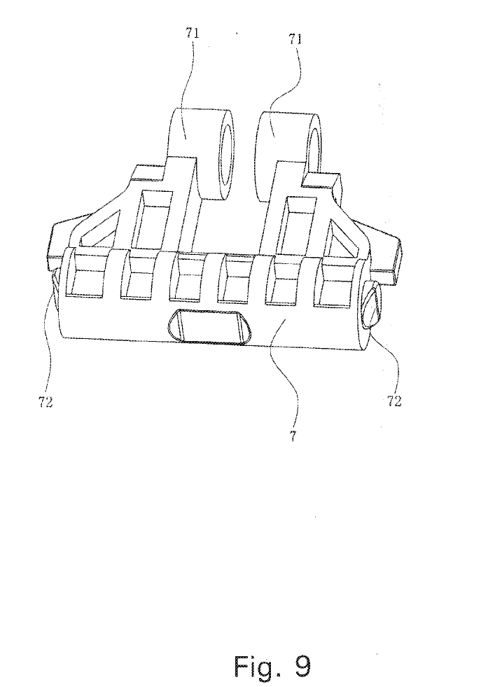

As shown in FIGS. 1 to 9, it concerns a preferred embodiment of a part driving structure of a coffee machine according to the present invention.

The part driving structure of the coffee machine includes a base 1, a first part 2 provided with a water outlet channel 21 and a second part 3 provided with a water inlet channel 31 for feeding hot water, wherein in the water outlet channel 21 there is a first one-way valve assembly 211 provided and in the water inlet channel 31 there is a second one-way valve assembly 311 provided.

The base in the present embodiment includes two portions: a frame 11 and a housing 12; the frame 11 includes a front retaining plate 111, a rear retaining plate 112 and two guide posts 113 supported between the front retaining plate 111 and the rear retaining plate 112 and arranged on the left and the right side parallelly at a distance to each other; the housing 12 is a hollow, generally rectangular plastic housing, in the front upper portion of the housing 12 there is a capsule inlet 121 provided for feeding capsules 18, and the guide posts 113 are movably guided through the housing 12 on the left and the right side so that the housing 12 and the frame 11 can slide relative to each other back and forth; there is a support spring 114 provided on each of the both guide posts 113 respectively, and the support springs 114 are supported between the front retaining plate 111 and the front end face of the housing 12; a retaining seat 15 having a cavity is fixed to the rear retaining plate 112, a piston 16 which can slide back and forth is disposed in the cavity of the retaining seat 15, a seal ring 17 is provided between an outer peripheral wall of the piston 16 and an inner peripheral wall of said cavity, a water inlet chamber 151 is formed between the rear end of the piston 16 and the cavity, the water inlet chamber 151 is in communication with environment through a cold water channel 161, and the cold water channel 161 is provided in the piston 16 in the present embodiment.

The first part 2 is fixed to the front retaining plate 111, the second part 3 is sheathed on the corresponding guide posts 113 on its left and the right side so as to be slidable back and forth, a receiving chamber for receiving capsules 18 is provided in the second part 3, and the second part 3 is located within the housing 12; a pushing board 4 that can slide back and forth relative to the base 1 is provided on the upper end face of the housing 12, the pushing board 4 is a rectangular plate; the pushing board 4 can cover the capsule inlet 121 when moving forward to the state where the first part 2 and the first part 3 are closed, while the pushing board 4 opens the capsule inlet 121 when moving backward to the state where the first part 2 and the second part 3 are completely opened.

A vertically disposed driving rod 5 is pivotally connected to the bottom surface of the pushing board 4, the upper end of the driving rod 5 is pivotally connected to a carriage 9 for guide wheels by means of its own pivot journal, first transmission rods 6 are pivotally connected to the rear end of the second part 3, a second transmission rod 7 is pivotally connected to the rear portion of the base 1, the rear end of the second transmission rod 7 is directly or indirectly pivotally connected to the piston 16, there is a mounting block 17 provided in the rear portion inside the housing 12, the mounting block 17 is sheathed on the guide posts 113 on its left and right sides, the rear end face of the mounting block 17 is in contact with the outer end face of the piston 16, the rear end of the second transmission rod 7 is pivotally connected to the mounting block 17 by means of pivot portions 71 on its both sides. The lower end of the driving rod 5, the rear ends of the first transmission rods 6 and the front end of the second transmission rod 7 are movably sheathed on one and the same transmission shaft 8.

There are two first transmission rods 6 provided, wherein the front ends of the first transmission rods 6 are pivotally connected to the back of the second part 3 by means of first pivot journals 61, and the rear ends of the first transmission rods 6 are sheathed on the transmission shaft 8; the front end of the second transmission rod 7 has two forwardly extending arm portions 72, and the front ends of the both arm portions 72 are sheathed on the transmission shaft 8; the lower end of the driving rod 5 is located between the both arm portions 72, the both first transmission rods 6 are located outside the both arm portions 72 respectively, and there is a jump ring provided on the left and the right end of the transmission shaft 8 respectively so as to axially restrain the first transmission rods 6, the second transmission rod 7 and the driving rod 5, wherein the jump rings are not shown in the drawings.

The rear portion of the second part 3 has an inner recess 32, the front ends of the first transmission rods 6 are pivotally connected within the inner recess 32 by means of the first pivot journals 61; in the state where the second part 3 is actuated by the pushing board 4 forward to be closed together with the first part 2, the lower end faces of the first transmission rods 6 get into contact with the bottom surface of the inner recess 32, preventing the first transmission rods 6 from further deflecting downward, with the axes of the first transmission rods 6 and the second transmission rod 7 including an obtuse angle α.

A carriage 9 for guide wheels is fixed to the lower end of the pushing board 7, the carriage 9 for guide wheels is fixed underneath the pushing board 4 by means of screws, and there are two mounting places 92 for the guide wheels provided respectively on the left and the right side of the carriage 9 for the guide wheels, wherein each of the guide wheels 91 is mounted in one mounting place 9 for guide wheel respectively, there is a guide shaft 10 provided in the inner upper portion of the base 1 respectively on the left and the right side, and wheel grooves on the guide wheels 91 on either side are in contact with the guide shaft 10 on the corresponding side. A first front magnet 13a is inserted in the front end of the carriage 9 for guide wheels, and a second front magnet 13b that corresponds to the first front magnet 13a is inserted in the middle portion of the housing 12; a first rear magnet 14a is inserted in the rear end of the carriage 9 for guide wheels, and a second rear magnet 14b that corresponds to the first rear magnet 14a is inserted in the rear portion of the housing 12; in the state where the second part 3 is actuated by the pushing board 4 forward to be closed together with the first part 2, the first front magnet 13a and the second front magnet 13b attract together with each other, while in the state where the second part 3 is actuated by the pushing board 4 backward until the first part 2 and the second part 3 are completely opened, the first rear magnet 14a and the second rear magnet 14b attract together with each other.

The operation principle and process of the present part driving structure of a coffee machine are as follows:

Capsule feeding process: the capsule 18 is feed from the capsule inlet 121, the pushing board 7 is pushed forward, and the upper end of the driving rod 5 underneath the pushing board 7 deflects forward generally about the transmission shaft 8 as a fulcrum; since the upper end of the driving rod 5 is restrained by the pushing board 7, during deflection of the driving rod 5, the transmission shaft 8 will be actuated to move down relative to the pushing board, so that the transmission shaft 8 will actuate the rear ends of the first transmission rods 6 and the front end of the second transmission rod 7 to move downward, and the first transmission rods 6 and the second transmission rod 7 gradually expand outward and remain horizontal, while because the rear end of the second transmission rod 7 is restrained by the mounting block 18, the second part 3 will be pushed by the second transmission rod 7 forward relative to the first part 2, at the same time the capsule 18 gradually enters into the recess 32 of the second part 3. In the state where the second part 3 is actuated by the forth movement of the pushing board 4 forward to be closed together with the first part 2, the first front magnet 13a and the second front magnet 13b attract together with each other, the pushing board 4 covers the capsule inlet 121, and the lower end faces of the first transmission rods 6 get into contact with the bottom surface of the inner recess 32, preventing the first transmission rods 6 from further deflecting downward, with the axes of the first transmission rods 6 and the second transmission rod 7 including an obtuse angle α.

Clamping process of the first part 2 and the second part 3: the cold water channel 16 is supplied with cold water under high pressure, the cold water under high pressure is pressed into the water inlet chamber 151 and drives the piston 16 to move forward relative to the retaining seat; because when the entire part driving structure is mounted, the retaining seat 15 is fixed to the rear retaining plate 112 of the frame, and the position of the housing 12 relative to the casing body of the coffee machine is fixed, the frame 11 will move as a whole backward relative to the housing 12 against the support force of the support springs 114, the first part 2 also moves backward relative to the housing 12, the first part 2 and the second part 3 are clamped against each other gradually under the water pressure to form a closed extraction chamber, and then coffee extraction process may take place, which process is similar to that of the prior coffee machines.

After the extraction is finished, the cold water channel 16 is released, the cold water under high pressure in the water inlet chamber 151 is discharged, the entire parts move forward relative to the housing under the action of the support force of the support springs 114, the locking force of the first part 2 and the second part 3 is removed, and then the pushing board 4 is pulled backward, the second part 3 is actuated by the pushing board 4 to move backward relative to the first part 2 under the action of the driving rod 5, the first linkages 6 and the second linkage 7; in the state where the second part 3 is actuated by the pushing board 4 backward until the first part 2 and the second part 3 are completely opened, the first rear magnet 14a and the second rear magnet 14b attract together with each other, the coffee capsule 18 is separated, the pushing board 4 opens the capsules inlet 121; in order to ensure security and hygiene of the coffee machine, when not in use, the pushing board shall be moved forward, and the pushing board 4 covers the capsule inlet 121.

1. A part driving structure of a coffee machine, the part driving structure comprising:
a base, having an upper portion, the upper portion comprising a capsule inlet;
a first part comprising a water outlet channel;
a second part comprising a water inlet channel, wherein the first part is coupled to a front end of the base, and the second part is moveably coupled to the base to slide back and forth;
a pushing board moveably coupled to a top surface of the base such as to slide back and forth relative to the base;
a driving rod pivotally coupled to a bottom surface of the pushing board;
a first transmission rod that is pivotally coupled to a rear end of the second part; and
a second transmission rod that is pivotally coupled to a rear portion of the base, wherein a lower end of the driving rod, a rear end of the first transmission rod, and a front end of the second transmission rod are coupled to a same transmission shaft.

2. The part driving structure of a coffee machine according to claim 1, further comprising:
a carriage coupled to the lower end of the pushing board;
guide wheels comprising wheel grooves, the guide wheels are mounted on the carriage; and
guide shafts located in the an inner upper portion of the base on respective left and the right sides, wherein the wheel grooves are in contact with the guide shafts, and wherein the upper end of the driving rod (5) is pivotally coupled to the carriage.

3. The part driving structure of a coffee machine according to claim 2, wherein the carriage is coupled underneath the pushing board by means of screws, and two mounting places for guide wheels are provided on respective left and the right sides of the carriage, wherein each of the guide wheels is mounted in one mounting place respectively, and the wheel grooves on either side are in contact with a guide shaft on a corresponding side.

4. The part driving structure of a coffee machine according to claim 3, further comprising:
a first front magnet inserted in a front end of the carriage;
a second front magnet that corresponds to the first front magnet, the second front magnet being inserted in a front portion of the base;
a first rear magnet being inserted in a rear end of the carriage; and
a second rear magnet that corresponds to the first rear magnet, the second rear magnet is inserted in the rear portion of the base, wherein in a first state where the second part is actuated by the pushing board forward to be closed together with the first part, the first front magnet and the second front magnet attract each other, and in a second state where the second part is actuated by the pushing board backward until the first part and the second part are opened, the first rear magnet and the second rear magnet attract each other.

5. The part driving structure of a coffee machine according to claim 1, wherein the pushing board is designed to cover the capsule inlet when moving forward to the state where the first part and the second part re closed, and the pushing board opens the capsule inlet when moving backward to the state where the first part and the second part are opened.

6. The part driving structure of a coffee machine according to claim 1, wherein the base further comprises a frame and a housing, the frame further comprising:
a front retaining plate;
a rear retaining plate;
guide posts supported between the front retaining plate and the rear retaining plate, the guide posts being arranged on the left and the right side parallelly to each other, wherein the guide posts are movably guided through the housing on the left and the right side so that the housing and the frame can slide relative to each other;
support springs sheathed on each of the guide posts, the support springs being supported between the front retaining plate and a front end face of the housing, wherein the capsule inlet is disposed in the housing, the first part is coupled to the front retaining plate, the second part is sheathed on the corresponding guide posts with its left and right sides and can slide back and forth, and the pushing board is disposed on the upper end face of the housing;
a retaining seat having a cavity is coupled to the rear retaining plate;
a piston that can slide back and forth is disposed in the cavity of the retaining seat;
a seal ring is provided between an outer peripheral wall of the piston and an inner peripheral wall of the cavity; and
a water inlet chamber that is formed between the rear end of the piston and the cavity, the water inlet chamber being in communication with environment through a cold water channel, wherein the rear end of the second transmission rod is pivotally coupled to the piston.

7. The part driving structure of a coffee machine according to claim 6, wherein the cold water channel is disposed in the piston.

8. The part driving structure of a coffee machine according to claim 6, there is further comprising:
a mounting block provided in the rear portion inside the housing, the mounting block is sheathed on the guide posts with its left and right sides,
wherein the rear end face of the mounting block is in contact with the outer end face of the piston, and
wherein the rear end of the second transmission rod is pivotally coupled to the mounting block by means of pivot portions on both sides of the second transmission rod.

9. The part driving structure of a coffee machine according to claim 8, wherein front end of the first transmission rod is pivotally coupled to the back of the second part by means of a first pivot journal, and the rear end of the first transmission rod is sheathed on the transmission shaft, the front end of the second transmission rod has forwardly extending arm portions, and the front ends of the arm portions are sheathed on the transmission shaft (8); the lower end of the driving rod is located between the arm portions, the first transmission rod is located outside the arm portions, further comprising a jump ring provided on the left and the right end of the transmission shaft respectively so as to axially restrain the first transmission rod, the second transmission rod and the driving rod.

10. The part driving structure of a coffee machine according to claim 9, wherein the rear portion of the second part comprises an inner recess, the front end of the first transmission rod being pivotally coupled inside the inner recess by means of the first pivot, journal, in the first state, the lower end faces of the first transmission rod contact the bottom surface of the inner recess preventing the first transmission rod from further deflecting downward, with the axes of the first transmission rod and the second transmission rod forming an obtuse angle (α).
